(19) United States
(12) Patent Application Publication
(10) Pub. No.: US 2010/0242300 A1
(43) Pub. Date: Sep. 30, 2010

(54) FREEZE DRYER BARRIER SYSTEM

(75) Inventors: David Debo, Tonawanda, NY (US); Ernesto Renzi, Youngstown, NY (US); Francis W. DeMarco, Niagara Falls, NY (US)

Correspondence Address: KNOBBE MARTENS OLSON & BEAR LLP, 2040 MAIN STREET, FOURTEENTH FLOOR, IRVINE, CA, 92614, US

(73) Assignee: IMA EDWARDS INC., Tonawanda, NY (US)

(21) Appl. No.: 12/514,067

(22) PCT Filed: Nov. 1, 2007
(86) PCT No.: PCT/US07/23070

§ 371 Date: May 7, 2009

Related U.S. Application Data
(60) Provisional application No. 60/864,612, filed on Nov. 7, 2006.

(51) Int. Cl. F26B 5/06; F26B 19/00; B23P 19/04

(52) U.S. Cl. 34/284; 34/92; 29/700

(57) ABSTRACT

This invention is directed to freeze dryers used in the pharmaceutical industry, and in particular, to a barrier system for freeze dryers located in an isolator or clean room facilitate sterilization of the isolator.

### FIELD OF THE INVENTION

This invention relates to freeze dryers used in the pharmaceutical industry, and in particular, to a barrier system for freeze dryers located in an isolator to facilitate sterilization of the isolator.

### BACKGROUND OF THE INVENTION

Freeze dryers typically incorporate a pressure vessel having a freeze drying chamber for receiving a plurality of containers or vials containing sterile material to be freeze dried. Access to the chamber for automated loading and removal of vials may be made through a rectangular opening or slot formed in a wall or in the main door of the chamber. The slot is closed by a slot door which, with the chamber, forms a vacuum seal around the slot. To enable vials to be inserted into and removed from the chamber, the slot door is vertically raised relative to the slot by moving the slot door along guide tracks.

When the pharmaceutical product is in the freeze dryer and the chamber is under vacuum conditions there is the risk of pulling air from the isolator or clean room into the freeze dryer chamber. It is current practice in the pharmaceutical manufacturing industry to perform freeze drying operations of the pharmaceutical products in an isolated system as opposed to a clean room. This is because there is less volume in an isolated system and therefore less volume to filter and sterilize.

Maintaining sterile conditions within the dryer requires periodic cleaning and sterilization of the slot door and guide tracks. In addition, the isolator periodically requires sanitizing, generally with a chemical agent such as vaporized hydrogen peroxide (VHP). Because VHP kills most organisms, if VHP were to enter the freeze dryer during pharmaceutical product processing, contamination could occur and the effectiveness of the pharmaceutical product could be reduced. In general, there is no indication that such a leak has taken place.

Therefore, improvements to the art of freeze drying are desirable and particularly improvements in the area of preventing harsh chemical agents from leaking from the isolator or clean room into the freeze dryer are needed.

### SUMMARY OF THE INVENTION

The present invention is directed to the operation of a loading system for a freeze dryer that is located inside an isolator or clean room environment wherein the isolator or clean room requires periodic cleaning using external agents. One embodiment of the invention comprises using two separate sealing means between the door and chamber of the freeze dryer, one seal being a static seal, e.g. an O-ring, and the other being an interactive seal, e.g. an inflatable gasket. The static seal provides a vacuum seal to maintain pressure in the freeze dryer while the interactive seal prevents the atmosphere outside the freeze dryer from entering into the freeze dryer. Another embodiment of the invention comprises providing a nitrogen barrier between the two sealing means, wherein the nitrogen barrier further prevents the outside atmosphere, such as that in the isolator, from entering the freeze dryer. In addition, the use of a nitrogen barrier allows for cleaning of the outside environment, such as sanitization of the isolator to be carried out even while freeze drying processes are being carried out. In embodiments where a plurality of freeze dryers are located within a single isolator, the isolator can be sanitized even when one or more of the freeze dryers are in operation and the cleaning agents are prevented from entering the freeze dryers.

As used herein, cleaning means the general reconditioning of the isolator or clean room, including sanitizing using harsh chemical agents such as vaporized hydrogen peroxide.

### BRIEF DESCRIPTION OF THE DRAWINGS

FIG. 1 is a plan view showing the sealing arrangement of sealing means and barrier gap between a freeze dryer chamber and door according to the present invention.

FIG. 2 is a plan view showing further detail of the sealing arrangement in accordance with the present invention.

### DETAILED DESCRIPTION OF THE PREFERRED EMBODIMENT

When a product is in the freeze dryer and the chamber is under vacuum conditions, air from the isolator or clean room may be pulled into the freeze dryer chamber. Use of isolators as opposed to clean rooms is becoming more common in the industry because isolators have less volume and therefore less volume to filter and sterilize. However, isolators must be periodically sanitized using a cleaning agent, such as VHP. VHP is often used because it destroys most organisms. However, if VHP penetrates into the freeze dryer, especially during product processing, it could contaminate the product and reduce its effectiveness.

The present invention provides an apparatus and method for preventing contamination of a freeze dryer chamber from the external environment, even during sanitization of the isolator. The present invention could also be used in any loading system that utilizes an isolator and requires that equipment in the isolator be environmentally separated there from during operation.

The present invention provides a sealing system for a freeze dryer wherein two separate sealing means are used to protect the freeze dryer chamber. In particular, a static sealing means, such as an O-ring, serves as a vacuum seal for the chamber and an interactive sealing means, such as an inflatable gasket, serves as a seal against the outside environment.

The present invention allows for a freeze dryer to continue freeze drying processes while sanitizing the isolator. In this scenario, the operating cycle includes having the vacuum chamber under vacuum during a freeze drying phase. As noted a static seal, such as an O-ring, acts as a main seal between the chamber and chamber door under vacuum conditions. In addition, an interactive sealing means, such as an inflatable gasket, is used as a further seal between chamber and chamber door and provides protection against the environment outside the freeze dryer, e.g. and isolator or clean room. To provide further protection, the present invention also provides for the introduction of an inert gas barrier between the two sealing means, i.e. between the O-ring and the inflatable gasket. The inert gas, such as nitrogen, barrier is maintained at a pressure higher than the isolator pressure. Therefore, the system allows for sanitization of the isolator during product processing in the freeze dryer chamber. In a first embodiment, the interactive sealing means provides protection against leakage of the sanitizing chemicals into the freeze dryer chamber. In a second embodiment, the inert gas barrier provides additional protection against such leakage. In this embodiment, even if a leak occurs in either of the sealing means, the higher pressure of the nitrogen barrier would prevent cleaning agents, such as VHP from entering the chamber.

Further advantages of the present invention include the use of the interactive sealing means to prevent steam from exiting the freeze dryer into the isolator or clean room during freeze dryer sterilization. In addition, the present invention allows the interactive sealing means to be automatically sanitized during the sanitization cycle of the isolator. In particular, when using an inflatable gasket as the interactive sealing means, the gasket would be inflated as normal during steam sterilization of the chamber. Then, during sanitization of the isolator, such as by VHP, the inflatable gasket would be deflated and the chamber would be under vacuum with no product in the chamber. The static seal would still provide a vacuum seal for the chamber, but the inflatable gasket would be sanitized along with the isolator.

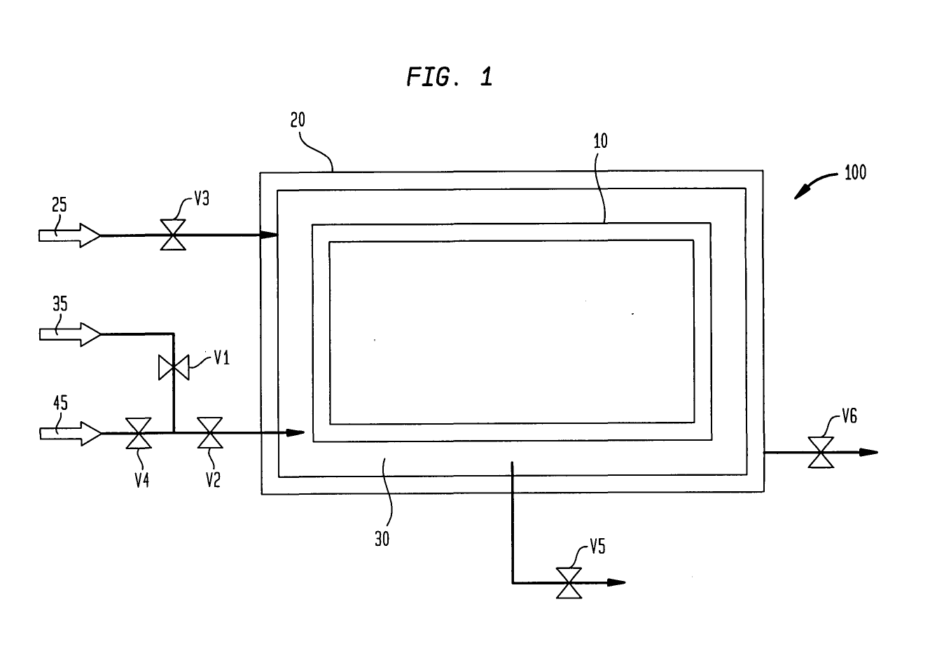

FIG. 1 is a plan view showing the sealing arrangement of sealing means and barrier gap between a freeze dryer chamber and door according to the present invention. In particular, FIG. 1 shows a freeze dryer 100 having sealing means comprised of a O-ring 10, an inflatable gasket 20, and an annular space 30 located between the O-ring 10 and inflatable gasket 20, wherein the annular space 30 can be filled with a pressurized inert gas, such as nitrogen, from an inert gas source 35 through valves V1 and V2. The inflatable gasket 20 is inflated by air or another suitable gas provided from gas source 25 through valve V3. In addition, FIG. 1 shows a steam source 45 that can provide steam to the annular space 30 through valves V4 and V2. FIG. 1 also shows an outlet from the annular space 30 that leads to valve V5 and allows steam to exit the system and pass to a drain. Moreover, FIG. 1 shows an outlet from the inflatable gasket 20 that leads to valve V6 and allows the inflatable gasket 20 to be deflated and the inflation gas to be vented.

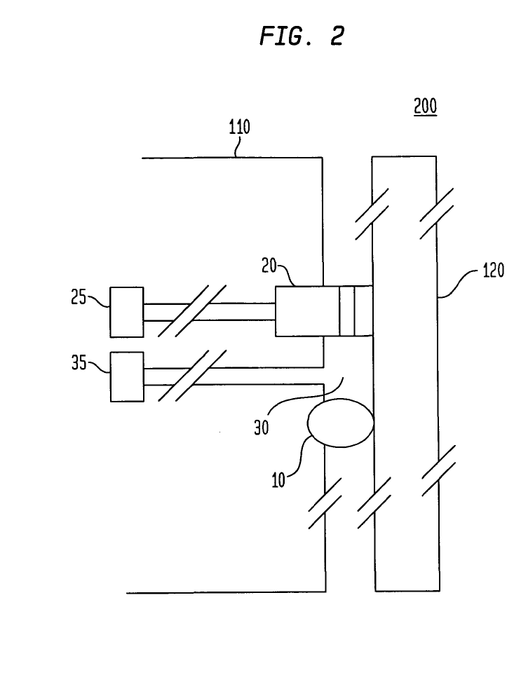

FIG. 2 shows further detail of the sealing arrangement of the present invention, wherein like elements are identified with like reference numbers. In particular, FIG. 2 shows freeze dryer chamber 110 and door 120 that can be sealed against the environment found in isolator 200 using O-ring 10, inflatable gasket 20 that can be inflated from gas source 25, and annular space 30 that can be filled with inert gas, such as nitrogen from inert gas source 35. The inflatable gasket 20 sits within a gasket slot on the opening side of the chamber door and the O-ring 10 sits in a ring slot.

In operation, the freeze dryer chamber 110 would be loaded with product to be treated and the door 120 would be closed. The freeze dryer operates under a pressurized atmosphere, typically from about 50 microns to about 300 microns, with a pressure of 100 microns being common. The O-ring 10 provides the primary vacuum seal, with the inflatable gasket 20 providing an further seal to prevent the environment outside of the freeze dryer, e.g. in the isolator 200 from entering into the chamber 110. Typical operating pressure for the isolator 200 is standard atmospheric conditions of 1 atmosphere. In accordance with the present invention, the annular space 30 between the O-ring 10 and inflatable gasket 20 can be filled with inert gas at a higher pressure than the pressure of the isolator 200, in order to serve as a further barrier against contamination of the chamber 110.

The relative positions of the inflatable gasket 20 and O-ring 10 are interchangeable to provide greater flexibility to the system and to meet particular needs of the user.

With reference to FIG. 1, the valves shown would operate according to the sequence shown in Table 1 for different phases of the operating cycle.

TABLE 1

| Phase | V1 | V2 | V3 | V4 | V5 | V6 |
|---|---|---|---|---|---|---|
| Freezing | Open | Closed | closed | closed | closed | closed |
| Operation | | | | | | |
| Isolator | Open | Open | closed | open | closed | closed |
| Sanitization | | | | | | |
| Chamber | Open | Closed | open | open | closed | open |
| Sterilization | | | | | | |
| Gasket | closed | Closed | closed | closed | open | closed |
| Sanitization | | | | | | |

Therefore, during the freezing operation, the inflatable gasket 20 would be inflated and operate with the O-ring 10 to seal and maintain vacuum in the freeze dryer chamber 110. While the inflatable gasket provides protection against the outside environment, during isolator sanitization, the annular space 30 may be filled with an inert gas at a pressure higher than that of the isolator 200 to further prevent the environment in the isolator 200 from entering the chamber 110. In addition, the annular space 30 can be filled with inert gas during the freezing operation for additional protection. During chamber sterilization, the inflatable gasket 20 would be inflated and steam would be injected into the annular space 30 and from there into a non-pressurized chamber 110 to sterilize the chamber 110. The inflatable gasket 20 prevents steam from exiting into the isolator 200. Instead steam exits the system to a suitable drain. During gasket sanitization, vacuum would be established in the chamber 110 and the O-ring 10 would provide a seal. The inflatable gasket 20 would then be maintained in a deflated condition allowing cleaning gas from the isolator 200 to interact and sanitize the inflatable gasket 20.

By providing the sealing arrangement of the present invention, contamination of the freeze drying chamber can be prevented, even during an isolator sanitization processes. In particular, the sealing arrangement of the present invention allows a freeze drying process to be carried out, even while isolator sanitization is simultaneously being performed. This is because the combination of the use of multiple sealing means e.g. O-rings and inflatable gaskets, and optionally filling of the annular space between the sealing means with an inert gas serves to completely protect against contamination of the chamber.

It is further noted, that it is common to have multiple freeze drying chambers operating in a single isolator. The present invention as described above will work equally well with any number of freeze drying chambers in an isolator. In fact, the present invention allows for advantageous use of such multiple chambers, as some can be in freeze drying operation mode, while others are being sterilized and while the isolator itself is being sanitized.

It will be understood that the embodiment(s) described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1-17. (canceled)

18. A barrier system for a freeze dryer for protecting the chamber of a freeze dryer from external contamination, comprising two separate sealing means placed between a chamber and a door of the freeze dryer.

19. A barrier system according to claim 18, wherein one sealing means is a static sealing means and the other sealing means is an interactive sealing means.

20. A barrier system according to claim 19, wherein the static sealing means is an O-ring and the interactive sealing means is an inflatable gasket.

21. A barrier system according to claim 18, wherein said to two sealing means having an annular space there between, and means to provide an inert gas to the annular space at a pressure higher then the pressure of the environment outside the freeze dryer.

22. A barrier system according to claim 21, wherein the two sealing means comprise an O-ring and an inflatable gasket.

23. A barrier system according to claim 21, wherein the inert gas is nitrogen.

24. The barrier system according to claim 21, wherein the environment outside the freeze dryer is an isolator or a clean room.

25. A method of protecting the chamber of a freeze dryer from external contamination by chemicals used to sanitize an isolator external to the freeze dryer, comprising sealing a door of the freeze dryer with the freeze dryer chamber using two separate sealing means.

26. A method according to claim 25, wherein one sealing means is a static sealing means and the other sealing means is an interactive sealing means.

27. A method according to claim 25, wherein the static sealing means is an O-ring and the interactive sealing means is an inflatable gasket.

28. A method of protecting the chamber of a freeze dryer from contamination by chemicals used to sanitize an isolator external to the freeze dryer, comprising sealing a door of the freeze dryer with the freeze dryer chamber using two separate sealing means that create an annular space there between; and filling the annular space with an inert gas at a pressure higher than the pressure of the isolator.

29. A method according to claim 28, wherein the two sealing means comprise an O-ring and an inflatable gasket.

30. A method according to claim 28, wherein the inert gas is nitrogen.

31. A method of performing a freeze drying process in a system comprising an isolator, and a plurality of freeze dryers housed within the isolator, each freeze dryer having two separate sealing means between a freeze drying chamber and a door wherein the two sealing means define an annular space there between, the method comprising: maintaining the isolator in a sterile condition at atmospheric pressure; placing a product within at least one of the plurality of freeze dryers; sealing the door of the at least one freeze dryer with its associated freeze dryer chamber using the two sealing means; and performing the freeze drying process on the product.

32. A method according to claim 31, further comprising filling the annular space with an inert gas at a pressure higher than the pressure of the isolator.

33. A method according to claim 32, further comprising sterilizing the isolator while simultaneously performing the freeze drying process.

34. A method according to claim 31, wherein the two sealing means comprise an O-ring and an inflatable gasket, and wherein sealing the door comprises creating a vacuum in the freeze dryer chamber so that the O-ring forms a vacuum seal between the chamber and the door and inflating the inflatable gasket to form a seal against the environment of the isolator while performing the freeze drying process.

35. A method according to claim 34, further comprising deflating the inflatable gasket and releasing the vacuum from the chamber; removing the freeze dried product from the freeze dryer; reestablishing a vacuum within the chamber so that the O-ring reforms a vacuum seal; and sterilizing the deflated inflatable gasket while sterilizing the isolator.

36. A method according to claim 34, further comprising deflating the inflatable gasket and releasing the vacuum from the chamber; removing the freeze dried product from the freeze dryer; re-inflating the inflatable gasket to reform the seal against the environment of the isolator; and injecting steam into the annular space to sterilize the chamber.
